(19) United States
(12) Patent Application Publication
(10) Pub. No.: US 2016/0225037 A1
(43) Pub. Date: Aug. 4, 2016

(54) System and Process for Rating Crowdfunding Campaigns and funding Campaigns by Crowdfunding websites with or without the help of user generated Ratings Scores

(71) Applicant: Seven E. Ezumba, Royal Palm Beach, FL (US)

(72) Inventor: Seven E. Ezumba, Royal Palm Beach, FL (US)

(73) Assignee: Funsidy LLC, Royal Palm Beach, FL (US)

(21) Appl. No.: 15/002,397

(22) Filed: Mar. 28, 2016

Related U.S. Application Data
(60) Provisional application No. 62/105,746, filed on Jan. 21, 2015.
(60) Provisional application No. 62/128,545, filed on Mar. 5, 2015.
(60) Provisional application No. 62/143,109, filed on Apr. 4, 2015.

(51) Int. Cl. G06Q 30/02; G06Q 50/00; G07C 13/00

(52) U.S. Cl. CPC G06Q 30/0279; G07C 13/00; G06Q 50/01; G06Q 30/0275

(57) ABSTRACT

The invention is based on a business process operation for a crowdfunding portal or website creating a new funding process and an online community where a pool of funds is been created by a percentage of donation activities on its portal, is used to fund automated selected campaigns on the crowdfunding portal, based on an algorithmic calculated score generated by users activity for each campaign. This pool of funds is governed by selected members of the portal. An advertising model is created to cater to the needs of project creators and a third party fundraiser commission payment model is created to encourage users to share various campaigns of crowdfunding portal. Invention creates a fundraising community of several activities carried out by interested parties with the common goal to raise funds for crowdfunding projects.

### CROSS-REFERENCE TO RELATED APPLICATIONS

Application No. 62143109
Filing Date: 2015 Apr. 4
Application No. 62/128,545
Filing Date: 2015 Mar. 5
Application No. 62105746
Filing Date: 2015 Jan. 21

### SUMMARY OF THE INVENTION

This Invention will create a general fund or pool of money (POM) that will be used to fund projects or campaigns on its portal or websites, based on an algorithmic calculated score from variables such as member or user feedback, rating and advice, length of project or days project has been live, social share count or number of times the project has been shared by users, social verification to verify the project creator's identity online, percentage to goal of project or how close they are to their funding goals.

The general Idea is to create a pool of money from the websites activities to fund needing projects selected by generated scores with the help of the general public registered on the website. Users or member feedback and advice will be generated from a star rating or voting system review. This pool of money will be placed in a trust (The Fund) and will be drawn down as deemed necessary to fund projects on its crowdfunding portal (www.funsidy.com)

An advantage of these inventions is that it will create a pool of money that otherwise would not be there to fund more projects. Funding more projects will improve the success rate of crowdfunding campaigns.

Another advantage is the fact that the selection is based on a calculation and not a few humans. The calculation takes account of various factors that affect a project life to generate a score. This way it is a collective decision and not the decision of a few people.

This Invention also solves the problem of harvesting the collective intelligence of the crowd to fund campaigns. It is very difficult for donors to donate to various random campaigns without making wrong decisions or have enough funds to go around. The invention of a POM and a calculated score would solve these problem with better success.

The purpose of this invention is to create a platform where the most campaigns possible get funded, with the collective intelligence of the crowd.

This invention creates a way to engage supporters and donors not only for their money but for their opinions, by selecting portal users based on criteria to be discussed, to act in voluntary adviser overseeing the POM on behalf of the portal. Allowing them to contribute to the day to day decision making of the portal.

This invention allows for options of 3rd parties to become fundraisers for original campaign creators. The invention allows campaign creators the option to allow users of the site to raise funds on their behalf by setting a percentage of donations the fundraiser raises toward the campaign as a compensation to the fundraiser.

This invention creates an advertising model that allows project creators advertise their campaigns. A problems with project creators and advertising is the lack of funds, since most project creators are trying to raise money from the start, the majority of them have no budget to advertise their campaign. This invention creates a model to make that possible.

### BACKGROUND OF THE INVENTION

The present invention addresses systems and methods for implementing the Jumpstart Our Business Startups Act (“JOBS”).

A simple definition of crowdfunding (alternately: crowd funding, crowd financing, equity crowdfunding, online fundraising) is a process in which individuals donate money and other resources to fund a project or campaign initiated by someone or an organization.

Crowdfunded projects or campaigns may include but not limited to creative works, products, nonprofit organizations, supporting entrepreneurship, businesses, or donations for a specific purpose (e.g., to pay for a medical procedure).

Crowdfunding usually takes place via an online portal that host the campaigns and may or may not handle the financial transactions involved, and may also provide services such as media hosting, social networking, and facilitating contact with contributors.

The crowdfunding arena has grown exponentially these past few years. We constantly hear of the successful funded projects or campaigns and rarely hear of the failed or under funded but worthy projects or campaigns. Currently in 2016 some estimates (not verified) put failed projects around 80% of all crowdfunding projects started.

There is also no way to harvest the collective intelligence of the crowd to fund campaigns, what we have today is individuals decisions focused on a particular campaign.

This present invention seeks to addresses these needs;
1. The need to help get more projects or campaigns funded on the crowdfunding portal or websites, effectively increasing its campaign success rate.
2. Protect the business model of creating a general fund or pool of money (POM) by a crowdfunding portal used to fund currently hosted projects based on a project score. This model can only work if it is protected and the invention not mass reproduced.
3. Provide advertising solutions to project creators to advertise their projects
4. Create an advisory board to overlook the activities of the fund from it members users.
5. Create a projects or campaigns selection process by way of the project score.
6. Monetizing fundraisers activities in order to compensate 3rd parties for time and effort.

A crowdfunding portal or websites that creates a pool of money used to fund projects or campaigns with no strings attached on its systems will help bridge that gap of unfunded or underfunded projects or campaigns deemed worthy of funding by majority users but fail or did not make their goals.

Currently there is no funding model or invented business process operation like this in the world. A pool of money, controlled by portal members, is used to fund various projects automatedly based on an algorithm calculated score. It is an invented way to help campaigns get extra help based on the algorithmic score of each campaign page, and advertise campaigns even when they lack funds to do so and allow willing 3rd parties to help campaigns reach their goal while getting compensated for efforts.

### BRIEF DESCRIPTION OF THE DRAWINGS

FIG. 1 illustrates the process and method for generating or raising funds used to funding crowdfunding campaigns or projects by the crowdfunding website or portal, the method comprising: a) by creating a fund (THE FUND).

FIG. 2 illustrates how the rating or voting system functions

FIG. 3 illustrates how the ratings evaluation and score is displayed on the campaign page

FIG. 4 illustrate how the social network shares are calculated and functions

FIG. 5 is a diagram of the process of advertising for project creators

FIG. 6 Is a diagram of the system for bid for advert space

FIG. 7 is a diagram of the system for bid for advert space example location

FIG. 8 is a diagram of the fix price advert space

FIG. 9 is a diagram of Payment from traditional payment methods for advert space

FIG. 10 Is a diagram of Payment from donation proceeds on crowdfunding portal for advert space

FIG. 11 is a diagram of Payment from points received from crowdfunding portal for advert space.

FIG. 12 is a diagram of fundraiser commission payment flow process.

FIG. 13 is a diagram of hire for help process

FIG. 14 is a diagram of hire for help user dashboard

FIG. 15 is a diagram of hire for help request service listings

FIG. 16 is a diagram of hire for help service provider request for service

FIG. 17 is a diagram of hire for help service offer listings on user dashboard

FIG. 18 is a diagram of review service provider reply and hire

### DETAILED DESCRIPTION

A crowdfunding portal or fundraising website will create a pool of money (POM) or a general fund, generated from donors contributions to POM and a percentage of donations or money received by individual crowdfunding projects or campaigns on it portal or websites. This to POM is used to fund crowdfunding projects or campaigns on its portal or websites periodically, based on needs such as project or campaign being partially funded, failed to fund or noteworthy ideas.

Note Periodically meaning; set daily intervals, monthly intervals, quarterly intervals, biannual intervals, or annual intervals.

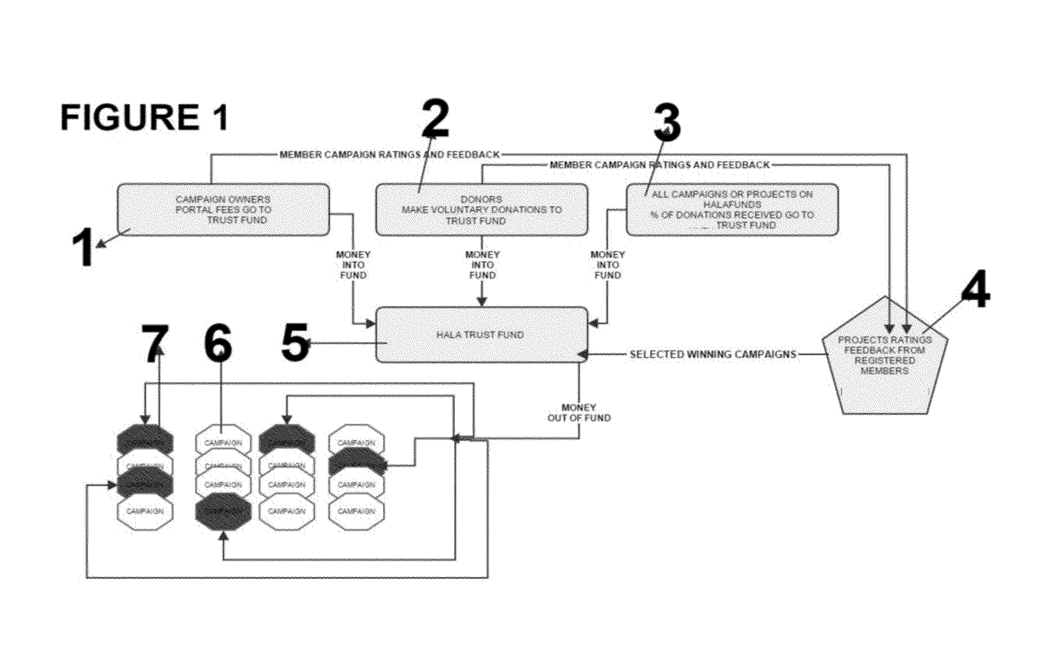

Generally, crowdfunding platforms have two types of users: individuals interested in supporting a particular project or campaign, and individuals interested in posting a project or campaign to attract donation and investment. Sometimes the same user may be both a supporter and a project or campaign creator. In order to function, crowdfunding platforms typically require users to register, by providing certain basic information about themselves. This process is illustrated in FIG. 1.

In step 1. this represents individuals interested in posting campaigns on the crowdfunding platform or portal. The campaign owners are allowed to create and post campaign for free. The portal will generate fees from campaign featured advertising and campaign renewal fees. A percentage of the fees will be dedicated to the POM or The Fund (step 5)

To create a campaign a user must register and become a member. Members are allowed to give feedback and ratings or voting on other posted campaigns on the portal, this feedback is then sent to the central database of portal (step 4) for evaluation and calculations, It will also be publicly displayed on step 7. and step 6.

In step 2.

Donors are the individuals interested in supporting campaigns or projects, donors are asked to make a voluntary donation to (step 5) POM or the fund, on every payment page for every campaign on portal.

The fund (step 5) will also have its own campaign page on the portal, to solicit donations just like every other project or campaign page. All donations gotten from step two are directed to step 5.

Donors will be register as members, so they will be able to give feedback, rate or vote on a campaign or project, these feedback is sent to step 4. and publicly displayed on step 7. and step 6.

In step 3.

Almost all crowdfunding websites charge a fee for the service they provide, these fees are taken from a percentage of donations made to the campaign itself. The Invented process charges a separate fee for step 5, which is a percentage of donations of all projects or campaigns on the crowdfunding platform, this percentage of fees will be deposited in Step 5 POM or The Fund.

In step 4.

All feedback are received from all members on the platform, this feedback is then calculated based on a set of parameters that will evolve with time and each campaign is awarded a score.

Step 4. also displays the average ratings for each campaign or project on their respective pages.

Step 4. collects all these feedback, ratings, and voting and selects the best projects to get funding, this information is then sent to step 5.

In step 5.

There is the general fund on the platform. It will run perpetually as long as the platform is in operation.

Step 5. collects funds from step 1.2. and step 3. The percentage of step 1 and 2 is determined by step 4. of the crowdfunding administration.

Step 5. collects 100 percent of funds from step 2.

Step 5 collects feedback and instructions from step 4. on chosen projects that it will then deposit funds to either partially fund or fully fund the campaign or project.

In this FIG. 1 illustration, step 5 donates funds to step 7 boxes, Indicating the instruction from step 4. that they have been chosen by to be funded and so automatically their project or campaign get the funding from step 5. pool of money.

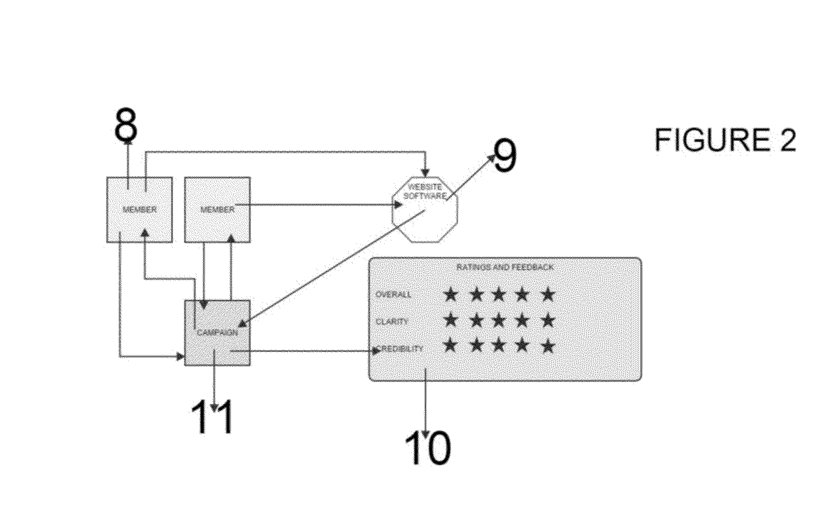

FIG. 2.

FIG. 2. illustrates the rating and voting system.

Step 8. This is a member account, either donors or campaign creators. One or more members view, evaluate and assess one or more campaign or projects, they rate on a 5 star rating system In step 10 or vote on any project or campaign page.

This information is sent to the admin of the crowdfunding portal Step 9.

Step 9 illustrates how the evaluated information from step 8 is then sent to step 11. to be displayed on public project page.

Step 9 is the crowdfunding software that calculates all feedback from step 8 and assesses scores and results for each individual project or campaign step 11.

Step 10 is an illustration of one of the ways ratings are being displayed and assessed on step 11. here in step 10 is a 5 star rating based on a). overall project b). clarity of project. c). credibility of project.

This ratings and questions will vary and change as website evolves, but the basics of users and members giving feedback by rating and voting on projects or campaign for the purpose of grading campaign or projects to be funded by the fund (step 5) will not change.

Step 11. is the campaign page that displays all ratings and assessments of step 10. by default on page.

This ratings will help other member by providing them insight to the general thinking of members on platform.

Step 10. will also encourage project creators to get feedback and adjust campaign to get better assessment.

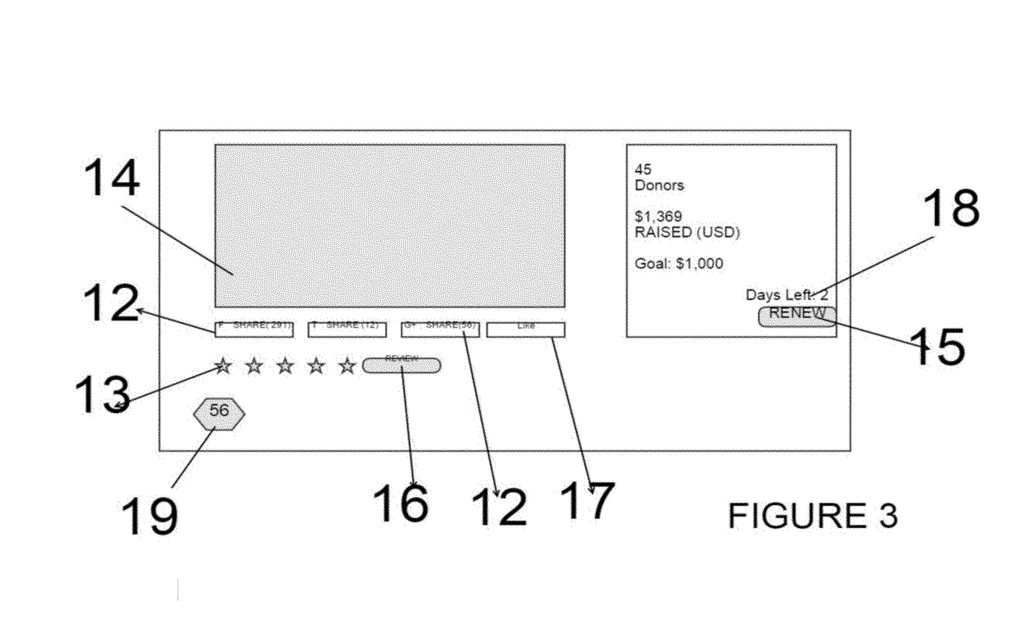

FIG. 3.

FIG. 3. illustrates how most of the ratings, score are displayed on campaign pages. It also illustrates how the campaign renewal feature in Step 15 works.

Step 15 will allow user to renew campaign for a set period of time for free or a fee. Step 18 will provide information on how long project or campaign has been running and how many days left to renewal.

Step 12. illustrates the social share buttons and its count. while this is already public information and not a new idea. The way Funsidy plans on using it towards the crowdfunding individual campaign for ratings purposes based on a cumulative calculation is what is the new invention.

The total number of shares and mentions from all social share plugins on campaign page will be counted or added up to get a total number, it will then be sent back to the main software and added in the equations to creating a score in Step 19.

Step 13 illustrates how the stars form step 10. can be displayed on each individual campaign page.

Step 14 is a general picture display. This is for here to create a better picture for illustration purpose, as this is not a new invention and very common among all crowdfunding website.

Step 16 illustrates the review button function. This is a clickable button that will open up and allow members to input their ratings and feedback and comments.

Step 17 illustrates the like button for the crowdfunding website, even though the like feature is popular on social networks, the inventions of using like counts to rate and evaluate campaigns for an opportunity to get funding by the crowdfunding website is a new invented process.

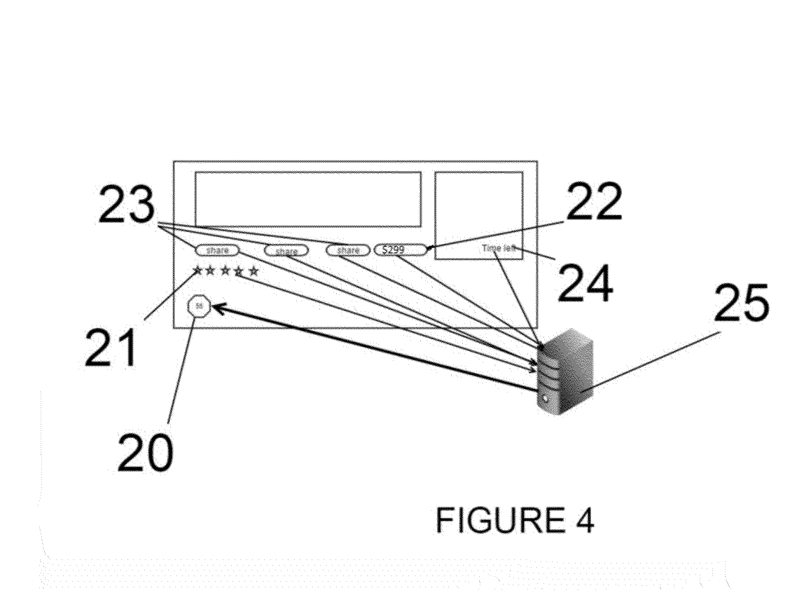

FIG. 4

FIG. 4. illustrates how all the components on a standard project or campaign page, are all sent into the mainframe software to create a score to be displayed. As noted this calculation will evolve with time but the basics of rating campaigns or projects will stay the same. the score calculation and code has been provided in this filing.

Step 20. is the score that comes from the main software in step 25.

Step 21. is the five star ratings average used as part of the score calculation. Step 21 sends feedback to step 25

Step 22. is the amount raised towards the goal. Step 22 sends feedback to step 25.

Step 23 are the social share counts sent to step 25 as part of the score calculations.

Step 24 is the lifespan or age of project on website and the expiring date of project, this information is also sent back to step 25. as part of the components used to calculate a score.

The crowdfunding portal or website system will select campaigns or projects to fund based on a score generated by each project or campaign.

An algorithm is used to generate a score in step 25 at any given time for each project or campaign, you can think of it like a credit score for project or campaigns.

These algorithm calculations are based on these variables:
1. Percentage to project goal
2. Project Ratings
3. Social share count
4. Social verification
5. Number of days project has been live on website

The general basic algorithm calculation performed by the website will vary for each project or campaign page. Here is the basic score calculation

Project Reviews

The campaign review is a quick easy glance of how Funsidy community view the project. Every registered user on Funsidy can review any and all campaigns or projects. We encourage everyone to review projects on Funsidy. This helps educate other users as well as project owners on how the project is viewed.

The campaign review is part of our scoring system which ultimately determines our patent pending Project Score.

Project Score

A Project Score is a simple formula that has been designed by Funsidy and is awarded to every single project. For better explanations, it can be called the credit score of each project.

The Project Score of each project will to change from time to time, depending on various factors.

The factors we use in our Project Score calculations;

Project reviews

Social shares count (facebook, twitter, emails, and on)

Percentage to project goals

Length of project

Project updates

Social verification

We combine these factors for each individual project on to come up with a score for that project.

Project Score Calculation

Maximum Project Score is 850

(35×850+25×850+20×850+15×850+5×850+5×850)/(35+25+20+15+5+5)

| Weight or % | Factor Number | Factor Explanation |
|---|---|---|
| 25% | 850 | Project reviews |
| 20% | 850 | Social shares count |
| 35% | 850 | Project % to Goal |
| 10% | 850 | Length of project |
| 5% | 850 | Project updates |
| 5% | 850 | Social verification |

Breakdown

Project Reviews

| Weight or % | Factor Number | Factor Explanation |
|---|---|---|
| 25% | 850 | Project reviews |

These are five star reviews given by registered users.

Social Shares Count

| Weight or % | Factor Number | Factor Explanation |
|---|---|---|
| 20% | 850 | Social shares count |

Social count will include the total number of;
   facebook shares—user shared the campaign on facebook
   twitter shares—user shared the campaign on twitter
   email shares—user shared the campaign via email
   number of supporters on—users subscribed to campaign
   number of comments—users commented on campaigns
For example a project has 15 facebook shares+25 twitter shares+5 email shares+35 supporters+15 comments=95 share count.
Negative counts
where a user shares a project but rates it below 1 star of below. That share count will minus from total count.
For example a project has 15 facebook shares+25 twitter shares+5 email shares+35 supporters+15 comments=95 share count. Then a new user shares the project and goes ahead to rate the project below 1 star. The new total count would be 94 share count because of the negative share count.

Project Goals

| Weight or % | Factor Number | Factor Explanation |
|---|---|---|
| 35% | 850 | Project % to Goal |

Each project has an amount of funds to raise to reach the goal set by the project owner. The closer the project gets to that goal, the higher your Project Score.

Length of Project
On funsidy projects run by default for 30 days, users have the option to extend the project each month.
Every 90 days or 1 month will affect the score positively.

Project Updates
Every time a project owner post updates to their projects, it improves their project score.

Social Verification
Simply verifying your identification on various social networks improves your Project Score.

25%=Project ratings (1000)
The star ratings (1 to 5 stars)*200.
example;
   1 star average will calculate as: 1*200=200
   1.5 star average will calculate as: 1.5*200=300
   2 star average will calculate as: 2*200=400
   2.5 star average will calculate as: 2.5*200=500
   3 star average will calculate as: 3*200=600
   3.5 star average will calculate as: 3.5*200=700
   4 star average will calculate as: 4+*200=800
   4.5 star average will calculate as: 4.5*200=900
   5 star average will calculate as: 5*200=1000
   or 2.7 star average will calculate as: 2.7*200=540

20%=Social shares count (3000)
Social count will include the total number of all these;
   facebook shares
   twitter shares
   email shares
   number of comments
These total number will have a maximum of 3000, after which any other share activity can not affect the score.
   example user has 15 facebook shares+25 twitter shares+5 email share+35 supporters+15 comments=95 share count.

5%=Project updates. (90)
*1 count
Every time a user updates his project, this action will positively affect the score. The maximum amount of times for project updates count is 90, after which any other update can not affect the score, and a max of one each day.

5%=Length of project. (90)
*10 count
This will be a 90 day count. every day will affect the score positively The 1 day *10.
example;
   1 month average will calculate as: 1*10=10
   2 month average will calculate as: 2*10=20
   3 month average will calculate as: 3*10=30
   12 month average will calculate as: 12*10=120

35%=Project goals (100)

What ever goal a user sets to get on his campaign is the project goal, the closer the raise money towards that goal, it helps their score.

### EXAMPLE

User A sets $1000 as his project goal, if he gets a $100 donation then he is 10% towards reaching his goal, that will equal to a project goal score of 10.

User A gets more donations of $400 making his total to be $500 dollars, he is 50% towards reach his goal, that will be a project goal score of 50.

5%=social verification. (500)

A Social verification by user will give them 5% of their score right away. which is 500

Project Score Codes

```
<?php
$data = array(
  array(25,850),
  array(20,850),
  array(35,850),
  array(10,850),
  array(5,850),
  array(5,850)
);
$dividend = 0;
$divisor = 0;
foreach($data as $value){
  $dividend += ($value[0] * $value[1]);
  $divisor += $value[0];
}
$average = $dividend / $divisor;
echo $average;
Breakdown
Five Star Ratings
  array(25, [symbol]   ),
          1 star =5 (25/5)
          2 star =10 2*5
          3 star =15 3*5
          4 star =20 4*5
          5 star =25 5*5
Social Share Count ( 3000 max share)
    array(20, [symbol]   ),
          1 share = 0.0066666667 ( 20/3000 )
    Percentage to Goal
    array(35, [symbol]   ),
          ( 35/the Goal)
          example: Goal is $100
          1% funding = .35 (35/100)
    Length of Project (90 days)
          array(10, [symbol]   ),
                Each day = (10/90)
    Project Updates ( 90 updates Max one each day.)
          array(5, [symbol]   ),
                each update = 0.0555555556 (5/90)
      Social Verification
                  array(5, [symbol]   )
                verified Social account gets 5 points.
```

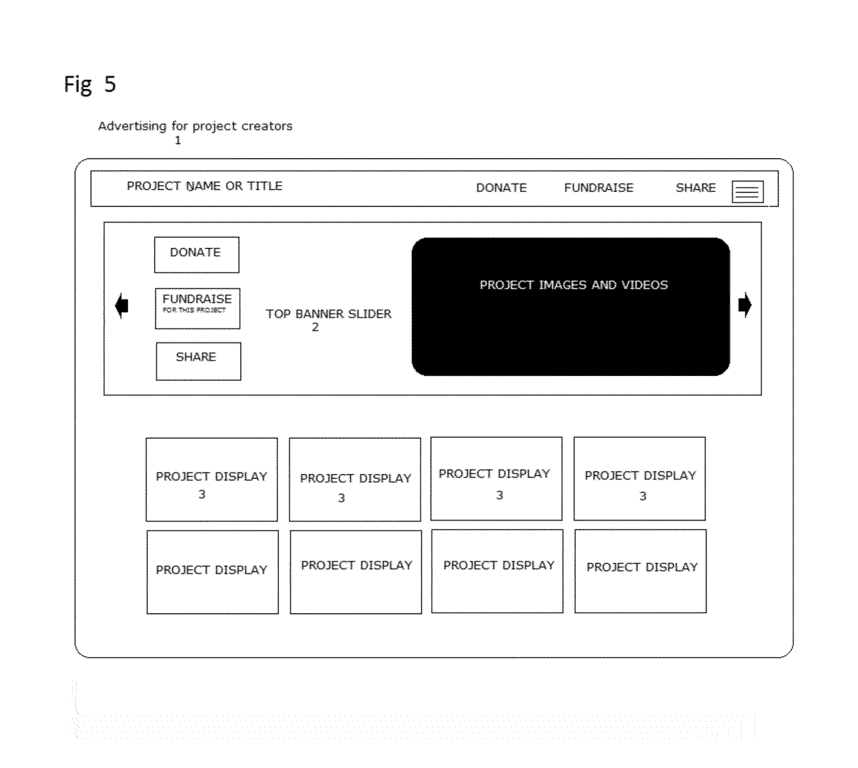

FIG. 5. is a diagram of the process of advertising for projects creators and ads locations on a crowdfunding website 1, the top banner slider of the crowdfunding website 2, is one of the main locations to display project adverts, this location 2, displays more details of the project that include the donation button, fundraise button, share button, and the images of the project and videos. the bottom boxes call project display 3, is another advert location on the main page and other pages of the crowdfunding website. fewer details are displayed here, such as project name, image and funding goals but not limited to details mentioned. this is done due to smaller nature of advert location. This locations will be reduplicated on all pages on the crowdfunding website as we deem necessary.

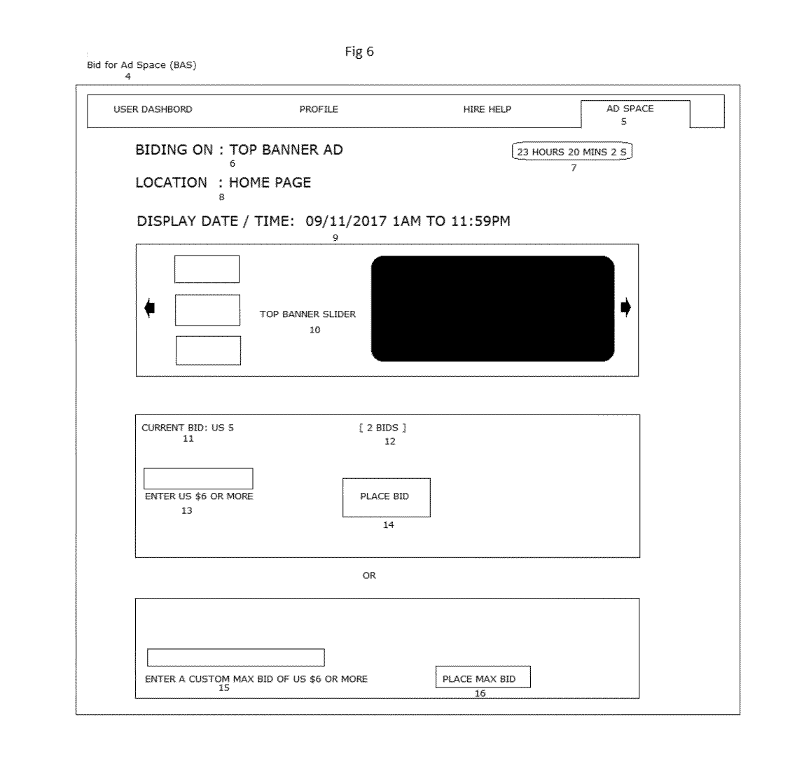

FIG. 6. is a diagram of the system for Bid for Ad Space (BAS) or Fix Price Ad Space (FPAS) 4, the project creator accesses this ad system from the user dashboard on the AD SPACE tab 5, here the advert system will display what advert position is up for Bid for Ad Space (BAS) or Fix Price Ad Space (FPAS) 6, the advert system displays the time remaining before Bid for Ad Space (BAS) or Fix Price Ad Space (FPAS) expires 7, the advert system displays the location of the advert up for Bid for Ad Space (BAS) or Fix Price Ad Space (FPAS) 8, the advert system will display what advert time of display is up for Bid for Ad Space (BAS) or Fix Price Ad Space (FPAS) 9, the advert system will display with graphic illustration where and how advert will possibly look on crowdfunding website Bid for Ad Space (BAS) or Fix Price Ad Space (FPAS) location 10, the advert system will display what is the current bid for current advert time and location 11, the advert system will display how many bids has been placed for current advert time and location 12, the advert system will display what is the minimum bid required to enter into bid system, here the is also a box to enter bid 13, the advert system will display a button PLACE BID for user to use to submit bid 14, the advert system will display an alternative box to enter max bid and minimum amount 15, the advert system will display what advert system will display a button PLACE MAX BID for user to use to submit max bid, here the system will automatically bid for the user till max amount reached 16.

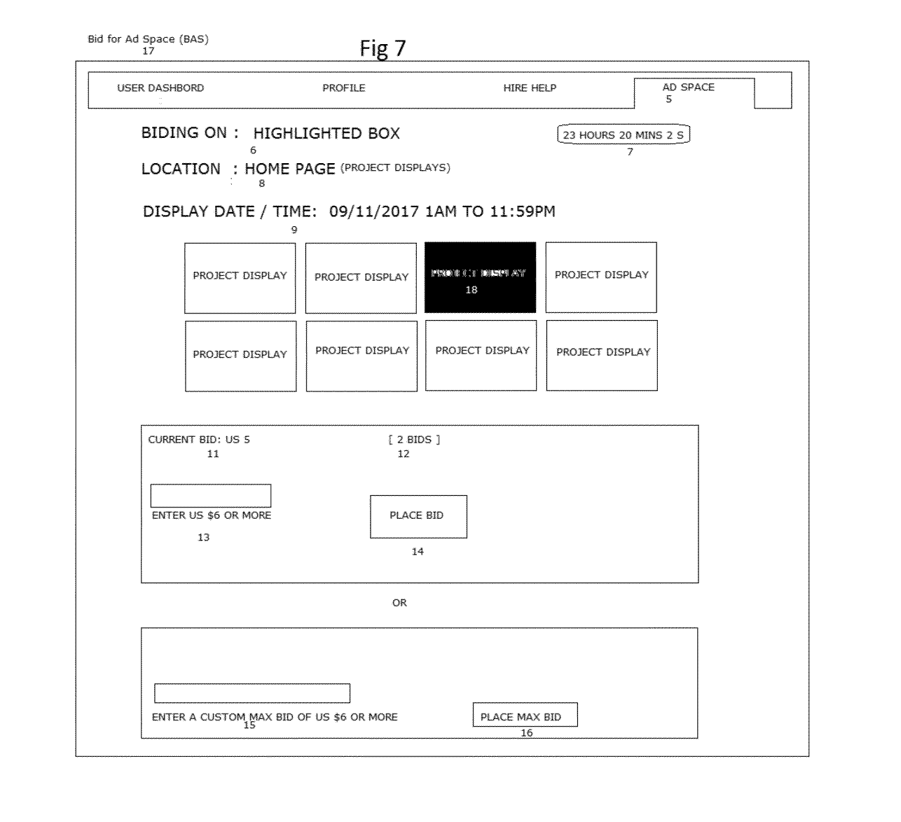

FIG. 7. is a diagram of the system for bid for advert space for a different ad location 17, the project display 18, is an example of another advert display location on the advert system.

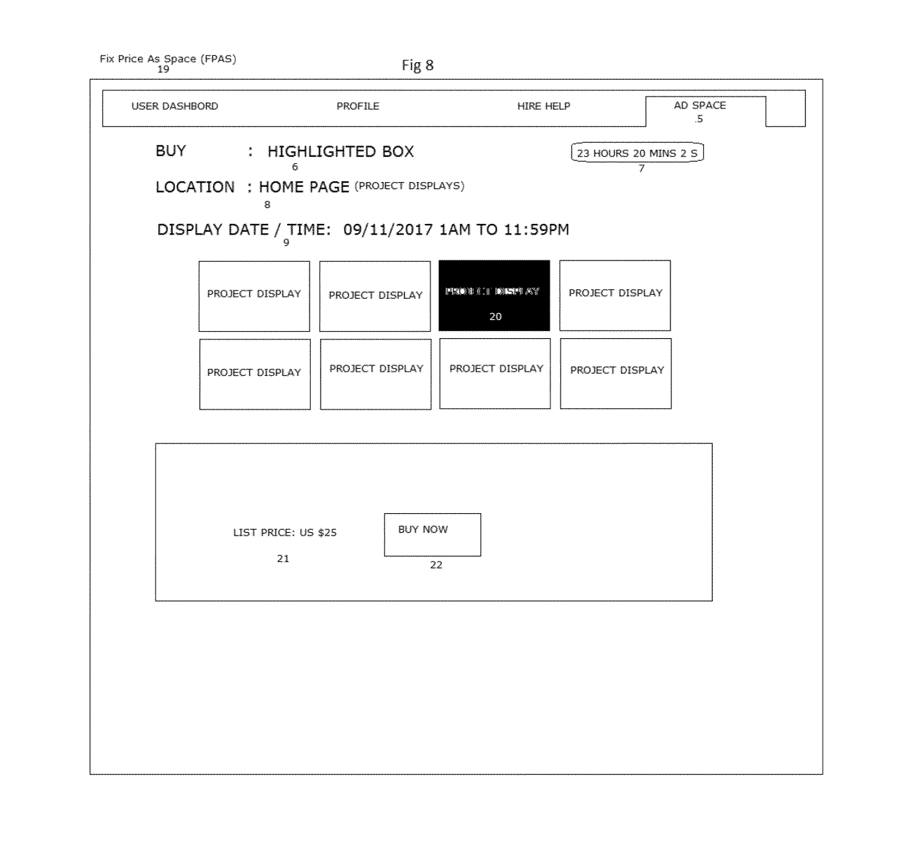

FIG. 8. is a diagram of the system for buying fix price advert Space on a crowdfunding portal 19, project display shows the location of advert on website 20, List price shows how much it will cost to buy the advert space 21, Buy Now box is the submission button to purchase the advert 20.

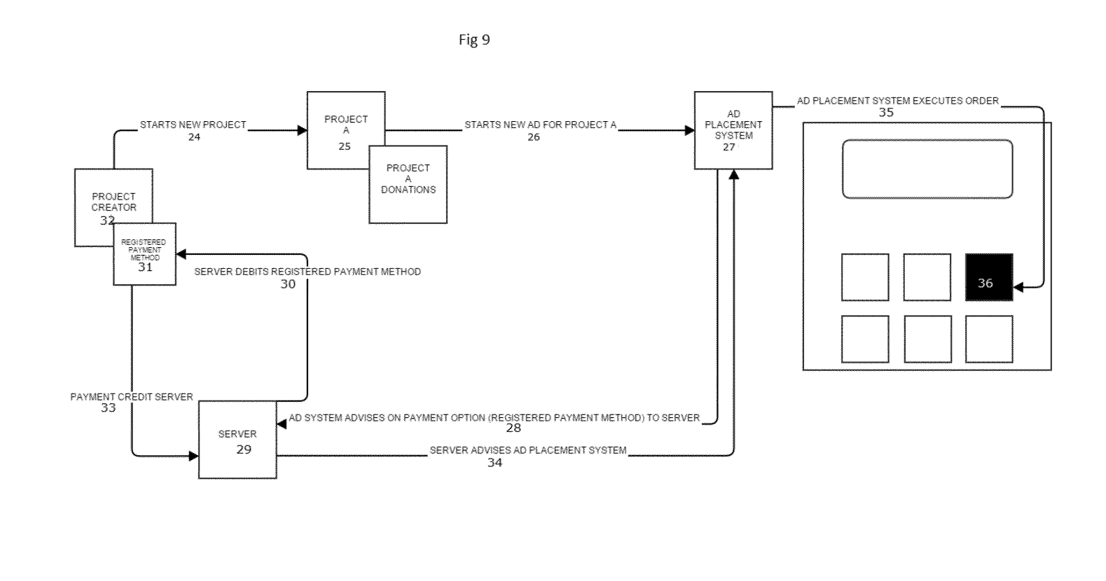

FIG. 9 is a diagram of the process for payment of advert via traditional payment methods 23, such a registered payments on crowdfunding portal, this registered payments include credit cards or third party companies like paypal, wepay, globalpay. 24, This process starts with a registered user creating a project 25, user then starts new advert for (Project A 25) by either place a bid or fix price buy 27, when user wins bid or agrees to buy fixed advert placement, Ad system will advise server on payment options for advert placed by the user 28, Servers now debit 30 (registered payment method 31 under user or project creator accounts 32) according to advice from ad system 28. Registered payment method 31, credit Ad placement system 27, via server 29, sever then advises ad placement system 34, on successfully credit. Ad placement system 27 getting advice from server 29, on successful credit from 31 executes the order 35, by placing ad at required location 36.

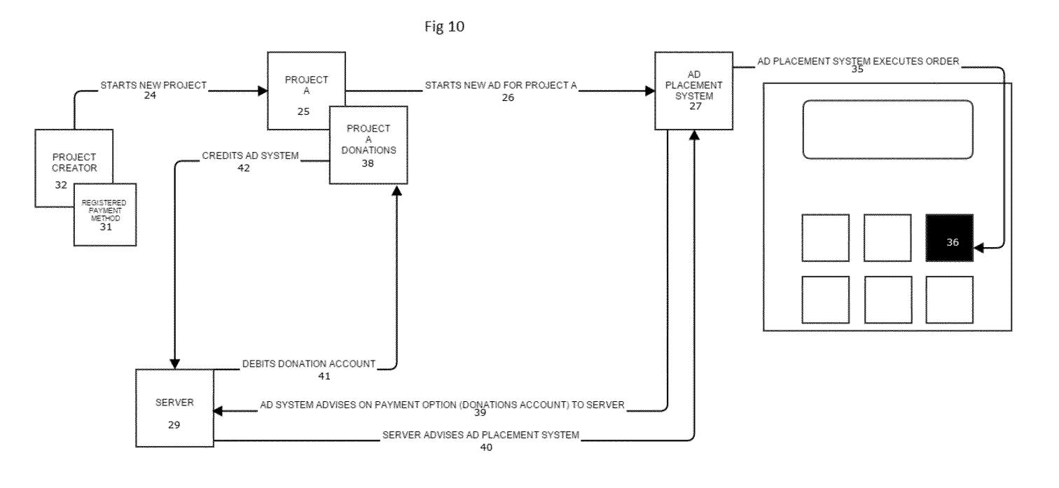

FIG. 10. is a diagram of advert payment process from donations proceeds on crowdfunding portal 37, Project creator 32 starts new 24 Project A 25.25 receives donations from various people 38. 32 Project creator starts new ad placements 26 for Project A 25. Ad placement system 27 advices on payment option 39 (payment via donation proceeds), server 29 debit (Project A donation 38) account 41, 38 project donation accounts credits Ad system 42 via server 29 server advices Ad system on payment 40, ad placement system 27, executes order 35, at required advert location 36.

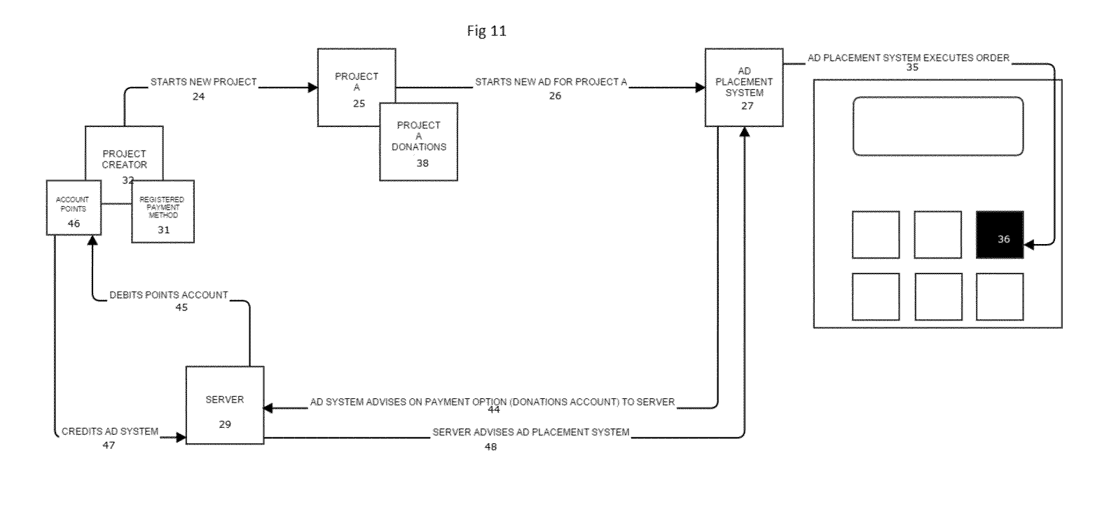

FIG. 11. is a diagram of advert payment process from points acquired on crowdfunding portal 43, Project creator 32 starts new 24 Project A 25. 32 Project creator starts new ad placements 26 for Project A 25. Ad placement system 27 advices on payment option 39 (payment via points acquired), server 29 debit (points 45) account 46, points 46 accounts credits Ad system 47 via server 29 server advices Ad system on payment 48, ad placement system 27, executes order 35, at required advert location 36.

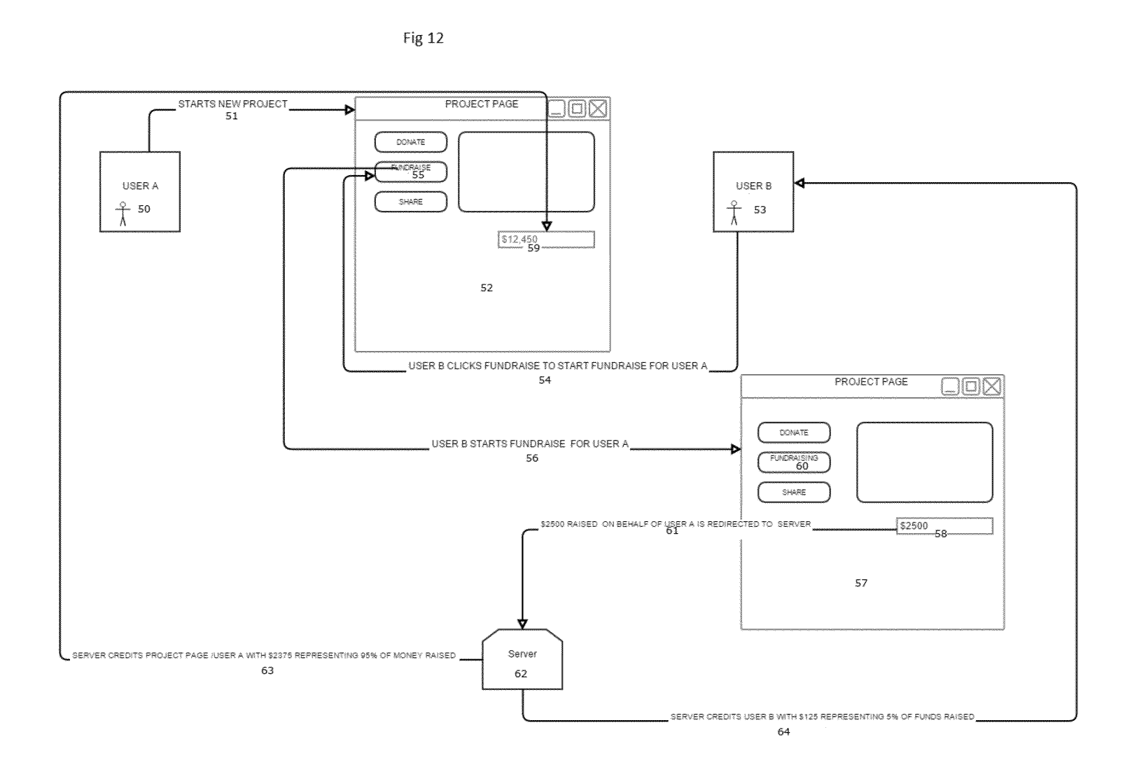

FIG. 12. is a diagram of the fundraiser flow process and compensation method 49, User A 50 starts new project 51, new project 52 is on public display on crowdfunding portal. User B 53, views project 52 and decides to fundraise for Project 52 by clicking on 55 (fundraise for this project) on 52, user b now starts a new fundraiser 56 (public fundraiser page 57) via 55 for user a 50 benefiting project 52. 60 is a button indicating which project is benefiting from the fundraiser. 58 is indicating how much money has be raised, all raised funds is redirected to server 62 on behalf of User A 50, project 52, Sever 62 credits 59 on project 52 less fundraiser commissions and credits User B 53 with fundraiser commission.

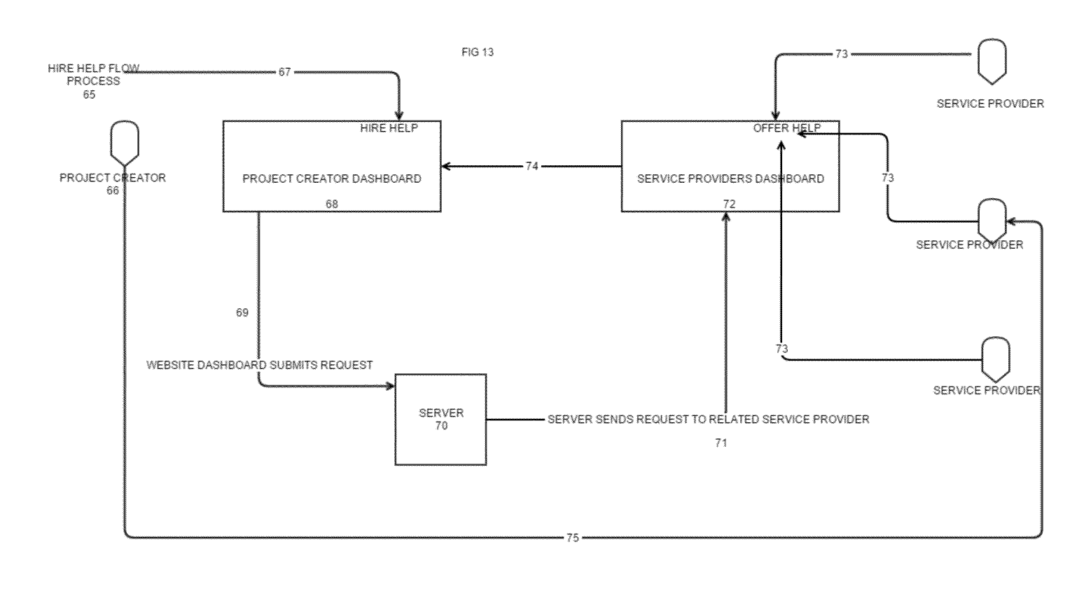

FIG. 13. is a diagram for hire help on crowdfunding portal flow process 65, project creator 66, clicks on hire help tab 67, on project creator dashboard 68, dashboard submits request 69, to server 70, server post request 71, to relevant service providers dashboard 72, service provider 73, views the request and offers help on any request, service providers dashboard 72, then sends all offers to 68 project creator dashboard.

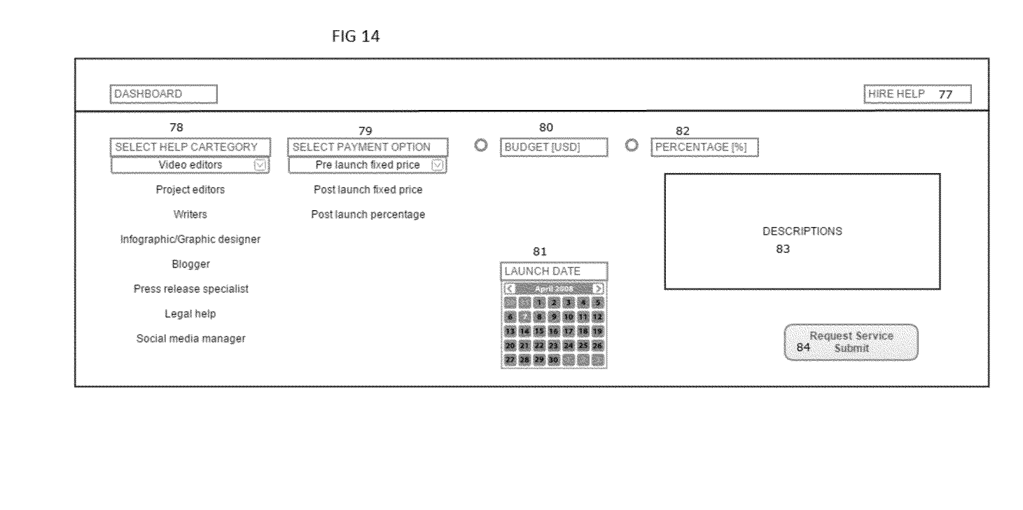

FIG. 14. is a diagram describing the hire help request service process 76, Project creator selects what category of service needed 78, project creator then selects payment options for the project 79, then project creator selects a budget 80, or a payout percentage of total project donation proceeds 82, project creator indicates planned launch date 81, writes a description of service requested 83, and submits request service 84.

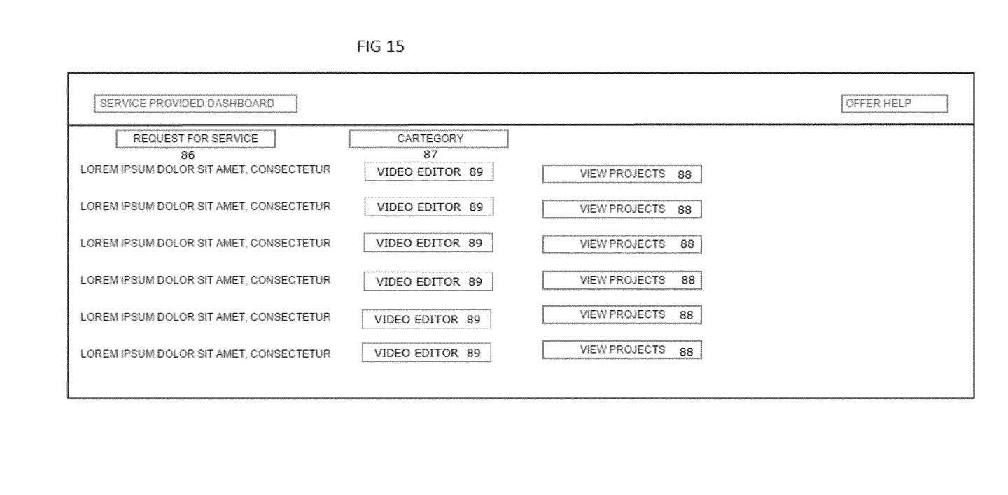

FIG. 15. is a diagram explaining the requested service list board 85, service providers view title of requested service 86, by category 87, service providers and view details about project with 88.

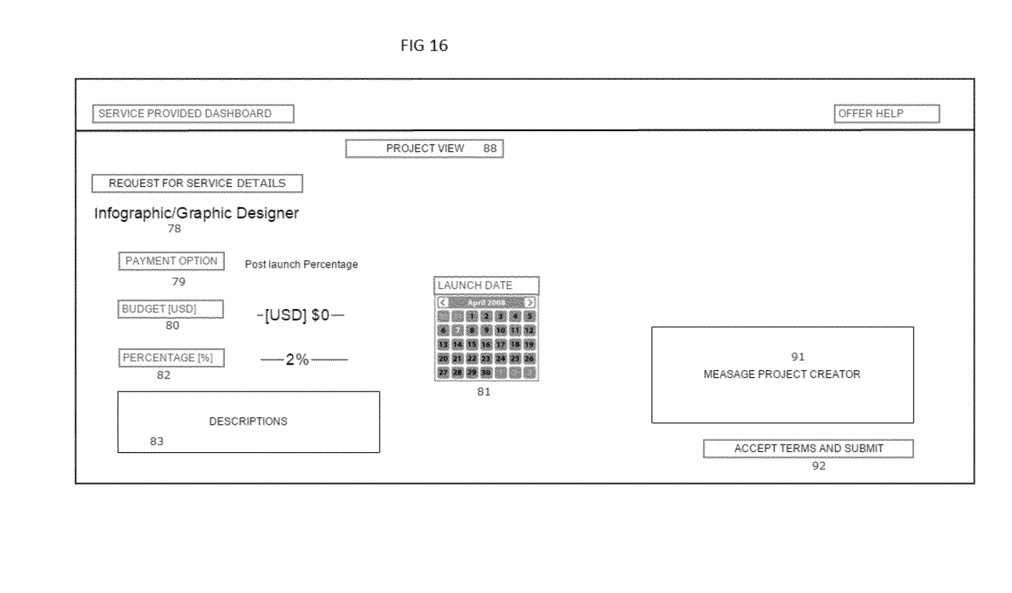

FIG. 16. is a diagram showing full details of a request for service by project creator 90, 78 is the category, 79 states project creators method of payment, 80 states the budget of amount project creator will pay for the service, 81 is the planned launch date, 82 is the percentage of donation proceeds project creator Is offering for service rendered, 83 is the description of service needed by project creator, 91 is a message box service providers uses to send a reply to project creator, 92 is the accept button and submit for review by project creator, service provider accepts all terms of the contract and makes himself available for hire by submitting and accepting terms of service.

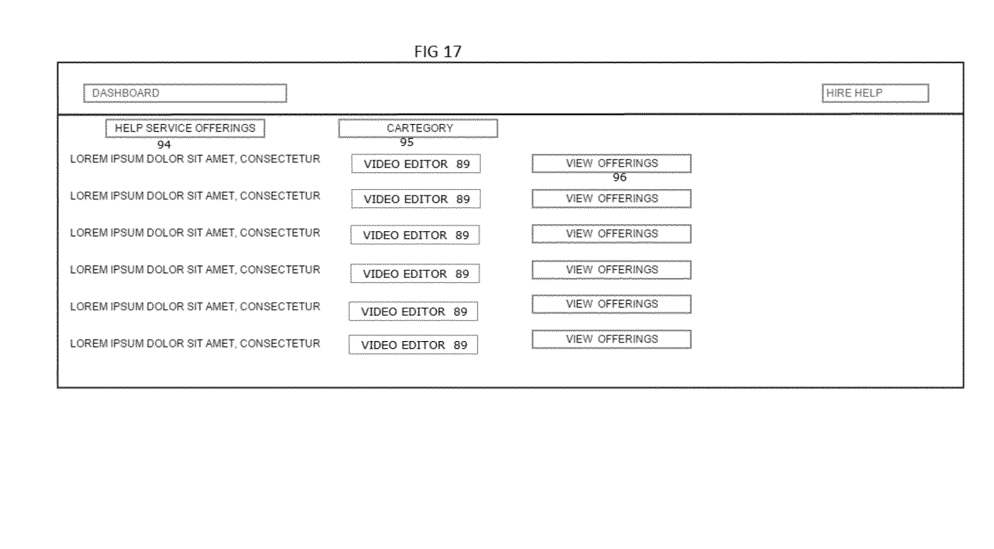

FIG. 17. 93 is the user dashboard service offer listing page, here all replied request for hire help is displayed here for the project creator to view and hire. 94 is the comprehensive list of all help offered, 95 is the category, 96 is a button to view details and hire on each offering,

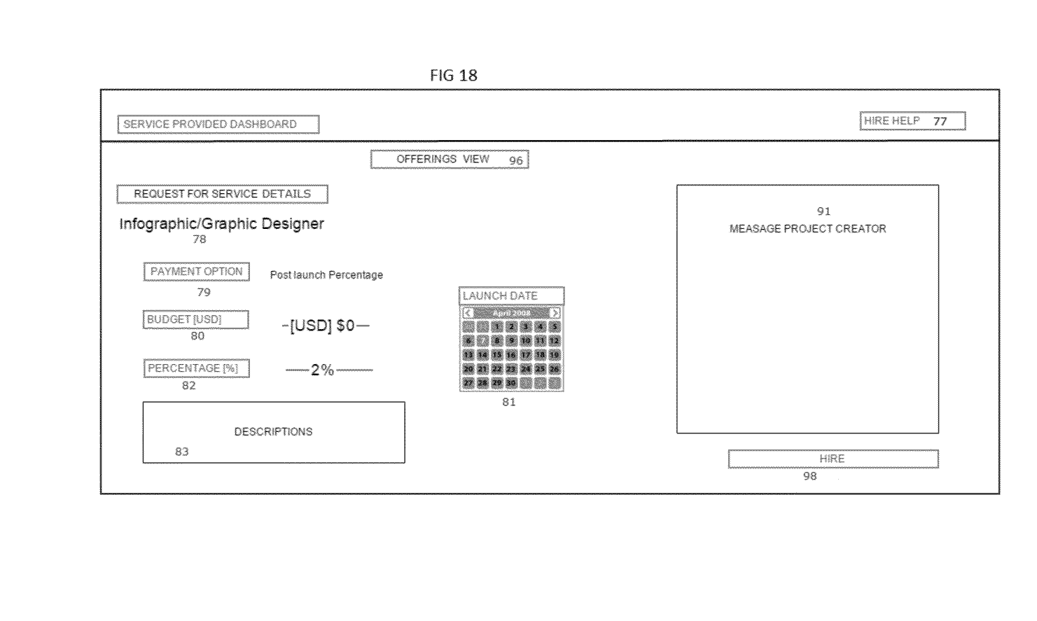

FIG. 18. is a diagram showing full details of an offer for service by service provider 97, 78 is the category, 79 states project creators method of payment, 80 states the budget of amount project creator will pay for the service, 81 is the planned launch date, 82 is the percentage of donation proceeds project creator is offering for service rendered, 83 is the description of service needed by project creator, 91 is a message box service providers uses to send a reply to project creator, 98 is the hire button project creator uses to select help to work with.

Users to Supervise the Operation of the Pool of Money

Selected portal users will be offered voluntary advisory roles to act as a decision making body overseeing the POM on behalf of the portal. Allowing them to contribute to the day to day decision making of the online company.

In the present day world, most for profit companies have either or both physical locations and online presence. These companies are managed by its founders or owners. They may elect to use any of the numerous management structures out there to manage their companies. This present invention introduces a new way to have interested parties or outside forces, alien to company ownership or other than the owners of a company, have their opinion count on the decisions a company would make. These interested parties or outside forces are classified as the company client base and as it relates to this invention the company online users.

The present disclosure is related to the field of social networking and crowdfunding, and more particularly to systems and methods in which web users registered on an online platform are ranked and selected to act as a decision making committee (adviser or board members) for the online platform. This process outlines the method of selecting a group from registered users, member, customers of an online company to a committee to act as a decision making board of the online company.

This invented process claims outright, the act of an online company using its registered users collectively as advisers or board members to collectively make decisions for the company, regardless of its selection process.

Selection will be based on a point system. This point system is based on the activity of each user on the online portal. Points will be awarded for various activities dohe on the online portal by individual user. These activities include but not limited to users making a donation to a project or cause, starting a fundraiser, supporting a project, reviewing projects, forum activities points, participating in interactive advertising, number of followers and likes, sharing and updating projects, profiles, blogs, forum, and all other user activity related events.

The present invented process identifies and selects registered users to act as a board or committee on the online platform.

Points are earned when you contribute positively to the online community

Ways to earn points.
Make a donation
Start a fundraiser
Support a project
Review projects
Forum activity
Participate in interactive advertisement.
Followers activity
Likes
sharing and updating projects, profiles, blogs, forum, and all other user activity related events.

Each activity is given a point weight. all points activities are summed up-to get total user points and compared against all registered users points to get a ranking.

Top ranked users are selected to the committee for a period of time. Selected members will be asked to provided opinion and advice on how portal should operate pool of money. This opportunity is voluntary to the user. Selected members will be awarded benefits and rights. These benefits and rights will evolve with time.

Creating an Advertising Model

Creating an advertising model for project creators to advertize their campaigns, a methods and process for generating and delivery of advertisements, fundraiser monetization payments for members of a crowdfunding portal.

The way our world raises funds is changing. The crowdfunding Industry is still in its infancy and growing. The SEC is still trying to formulate rules for regulations of the crowdfunding industry. As individuals and organizations become accustomed to crowdfunding in an online social context, there will be need for new types of services. In this new economy there is a strong need for services that help all interested parties as it relates to crowdfunding.

The traditional market for crowdfunding services online is highly fragmented. In today's market, there are virtually no forms of crowdfunding advertisement, fundraiser commissions, or hire for help in a crowdfunding portal or website system. Voluntary or independent fundraisers are not included in any form of commission based on the work they carry out on crowdfunding portals or websites. Project creators are left to their own faith, to find help services for creating and running their campaigns outside of the crowdfunding portals. Advertising of projects and other advertising are non existent in the crowdfunding portals. Even in today's market, thousands of service providers, both individuals and companies, offer their services, but their individual websites or online postings are often difficult to find or do not disclose sufficient information regarding the quality of their work product, reputation, or availability. The lack of an arena where all crowdfunding interested parties can meet and help each other make the crowdfunding Industry time-consuming, inefficient and costly for people who require and offer crowdfunding services.

The displacement of the crowdfunding services online has therefore created a strong need for infrastructure that can facilitate access to service in an efficient manner.

The present invention is broken down into six
I. method of crowdfunding advertising via a crowdfunding platform
II. method of payments of crowdfunding advertising via a crowdfunding platform
III. method of fundraisers commission and fee participation on a crowdfunding platform
IV. Method of fundraisers payment and determinations of percentages or fees on crowdfunding portal or website.
V. method of hire for help on a crowdfunding platform
VI. method of payments for hire for help on a crowdfunding platform

All these service infrastructure, will create a 360 environment where all the needed tools are required to grow the industry and foster best practices.

Method of Crowdfunding Advertising on a Crowdfunding Platform
The method of crowdfunding advertising for project creators
Advertising for Project Creators
This invention has created an infrastructure where project creators can participate in a Bid for Ad Space (BAS) on a crowdfunding portal and embed external advertising box display for third party's site. Allowing project owners to enter into auction like bids for space locations and time of display on the crowdfunding portal and affiliates. Project creators will have the option to enter a specific amount of money to place a bid, for a particular ad space location for a particular time display, for example; $5 on front page-top banner ad from 12 am to 12 pm on Dec. 13, 2027, furthermore, project owners can place max bid for a particular ad space location for a particular time display, for example; $25 max bid on front page top banner ad from 12 am to 12 pm on Dec. 13, 2027.
This present invention allows project owners to feature their projects for more exposure and visibility on a crowdfunding portal.
This invention has created an infrastructure where project creators can buy Fix Price Ad Space (FPAS) on a crowdfunding platform, for a particular location and for a particular time.

Method of Payments of Crowdfunding Advertising on a Crowdfunding Platform
This method of crowdfunding payment for advertising is broken down into three
   payment from donation proceeds on crowdfunding portal
   payment from traditional payment methods
   payments from crowdfunding points
Payment from Donation Proceeds on Crowdfunding Portal
This invention has created the infrastructure to give users options to use pre or post donation proceeds to use as credit to Bid for Ad Space (BAS) or Fix Price Ad Space (FPAS) on a crowdfunding portal. Project creators can use donation money to apply as credit to Bid for Ad Space (BAS) on a crowdfunding portal. When this happens users donation account will be debited as soon as money is available. This payment will debit account owner for the amount spent on (BAS) immediately, if for some reason the money is not available or not enough due to account owner withdraw, system will try to debit account owner registered form of payment or debit account as soon as more donations are collected. Process flow Bid for Ad Space (BAS) or Fix Price Ad Space (FPAS) advise server of debit.
   Server debits donation account.
   Donation account credits Bid for Ad Space (BAS) or Fix Price Ad Space (FPAS) via sever.
   Server Advices Bid for Ad Space (BAS) or Fix Price Ad Space (FPAS) Bid for Ad Space (BAS) or Fix Price Ad Space (FPAS) executes ad placement.

Payment from Traditional Payment Methods
This invention allows users to use traditional forms of payment to debit for BAS or (FPAS). payment will be done by register payment method. Process flow Bid for Ad Space (BAS) or Fix Price Ad Space (FPAS) advise server of debit.

1. Creating a fund (THE FUND) or pool of money (POM), on its portal or other website systems, for the purpose of raising money to fund unfunded campaigns, under-funded campaigns or chosen crowdfunding campaigns, projects or individuals on its portal or other websites by the portal, the method comprising:
A. by pooling or putting money aside in a fund (THE FUND) from a percentage of donations or money received by individual projects or campaigns on it portal or websites or system of services, to use to fund campaigns projects on its portal
B. by charging a fee from donations made to individual projects, to be put aside in the fund, for the purpose of funding unfunded or underfunded or chosen crowdfunding campaigns or projects on its portal or website.

2. A method for using variables below for each project or campaign to generate a project score, that is used to select campaigns or project or individuals to fund on the portal or other website systems. the method comprising:
a. project or campaign creator who is referred to as (user, creator or member) creating a project or campaign on portal;
b. donors or supporters who are referred to as members and project campaign creators, provide evaluation by rating or voting on any campaigns on the crowdfunding portal,
c. calculating each campaigns evaluations based on rating or voting of members and users with a five star rating system on each project or campaign page,
d. calculating each campaigns evaluations based on social network share count
e. calculating each campaigns evaluations based on time duration of each campaign
f. calculating each campaigns evaluations based percentage to goal or fund target of campaign
g. calculating each campaigns evaluations based online social verification
h. displaying calculated evaluation information associated with each campaign or project on campaign or project public profile for public view,
i. Using calculated evaluation information associated with each campaign or project as one of the crowdfunding decision tools to select and award funding to best campaign or projects in need or top rated scored projects,
To evaluate and award funding to a project or campaign, the crowdfunding portal algorithm will calculate a score based on users or members will generated review, campaign star rating or voting and reviews along with comments and feedback, including social networking and other websites feedback such as share count, length of project, percentage to project goal, social verification and mentions relating to a specific project, to prioritize, classify, evaluate and decide which project or campaign get funding at set periodic time, for example annually, quarterly, monthly or bi annually. Members will only be able to rate once per project or campaign but will be allowed to change rating or voting on same project in the future. Only registered member or donors will be able to rate projects or campaigns.

3. A software medium comprising codes and instructions, which when executed by one or more processors, perform the following operations:
A. Calculating each campaigns evaluations based on rating or voting of members and users
B. Displaying calculated evaluation information associated with each campaign or project on campaign or project public profile for public view,
C. Use the percentage to project fund target or goal (funds needed by a campaign) as part of the algorithm to calculate the project score,
D. Use the length or life on project on portal as a variable for the score calculation,
E. Using calculated evaluation information associated with each campaign or project as one of the crowdfunding decision tools to select and award funding to best campaign or projects in need,
F. Social share or mention will be provided on the crowdfunding campaign page of each project or campaign
G. The generated score of each campaign will be calculated and used as part of the crowdfunding decision tools to select and award funding to best campaign or projects in need,
H. Provide and display to public on project or campaign page the assessments, ratings and score for specific campaign or project
I. Use these assessments, ratings, and score created by users or members of the crowdfunding website as decision tools to select and award funding to best campaign or projects in need.

4. Projects or campaign will run on a monthly basis, with options to renew for free or a fee. This is a needed feature of method of claim 1, this helps with classification and pre qualification of projects or campaigns that would qualify for eventual funding, as this enable portal or website software to query the system on set based criteria to select matured pre qualified projects or campaign on the portal; a) set rules on campaign lifespan (amount of months project or campaign has been live on portal) will be set by our system to predetermined or prequalify campaigns for funding by the crowdfunding fund (The Fund)

5. Process of advertising on a crowdfunding portal or website, comprising bidding by project creators for project advert space on the crowdfunding portal or website, buying at a fixed price project advert space on a crowdfunding portal or website.

6. Where bidding for project advert space will include time of display of advert on crowdfunding portal or website.

7. Where bidding for project advert space will include location of display of advert on crowdfunding portal or website,
Where bidding for project advert space will include payment method. This method of crowdfunding payment for advertising Is broken down into three
payment from donation proceeds on crowdfunding portal
payment from traditional payment methods online
payments from crowdfunding points

8. Process of providing commission and fee participation on a crowdfunding platform or website for users who take on the role of fundraisers for another project on crowdfunding website or portal.

9. Process where the crowdfunding portal payment system automatically or manually splits donations raised between a beneficiary and a fundraiser based on a percentage arrangement for a campaign or project by the project creator or portal.

10. Process of offering advertising credits to campaigns or projects on it portal to use to advertise their projects on its portal or other websites.

11. Process of recovering advertising credits from campaigns or project from donations made to the campaigns.

12. Process of creating predetermined methods of payments; 1. Pre launch fixed price, payment for service is paid before project Launch. A predetermined fixed price is selected by project creator. 2. Post launch fixed price, payment for service rendered at fixed price is paid after launch of the project and during the course of the life of the project. payment is made incrementally on at a percentage of every donation until fix price payment is paid off. 3. Post launch percentage, payment is made on a set percentage of total donation to project for service rendered.

13. A method for providing online, web-based company advisers or decision making group over the Internet comprising: Its general user, including but project or campaign creators, donors, freelancers and general registered users.

14. Each activity is given a point weight. all points activities are summed up to get total user points and compared against all registered users points to get a ranking.

15. Top ranked users are selected to the committee for a period of time. Selected members will be asked to provided opinion and advice on how portal should operate. This opportunity is voluntary to the user. Selected members will be awarded benefits and rights. These benefits and rights will evolve with time.

16. A method of selecting a decision making body for an online company, using a points system to select top ranked users: Points are awarded to users based on various activities on website Including
Making a donation
Starting a fundraiser
Supporting a project
Reviewing projects
Forum activity
Participate in interactive advertisement.
Followers activity
Likes
sharing and updating projects, profiles, blogs, forum, and all other user activity related events.
